(19) United States
(12) Patent Application Publication
(10) Pub. No.: US 2020/0277057 A1
(43) Pub. Date: Sep. 3, 2020

(54) FLOW CONTROL METHOD, APPARATUS AND SYSTEM FOR LIQUID EXTRACTION APPARATUS OF PLANT PROTECTION MACHINE

(71) Applicant: SZ DJI TECHNOLOGY CO., LTD., Shenzhen (CN)

(72) Inventors: Xiongfei SHI, Shenzhen (CN); Gang HE, Shenzhen (CN)

(21) Appl. No.: 16/875,653

(22) Filed: May 15, 2020

Related U.S. Application Data
(63) Continuation of application No. PCT/CN2017/116873, filed on Dec. 18, 2017.

(51) Int. Cl. B64D 1/18; A01M 7/00; F04B 49/06; F04B 49/20

(52) U.S. Cl. CPC B64D 1/18; A01M 7/005; A01M 7/0089; B64C 2201/12; F04B 49/20; B64C 2201/042; F04B 49/065

(57) ABSTRACT

A flow control method includes obtaining a target flow rate for extracting liquid, determining a target rotation speed of a liquid extraction apparatus corresponding to the target flow rate based on a preset association relationship between a flow rate and a rotation speed of the liquid extraction apparatus, and controlling the liquid extraction apparatus to rotate at the target rotation speed to extract liquid.

### CROSS-REFERENCE TO RELATED APPLICATION

This application is a continuation of International Application No. PCT/CN2017/116873, filed on Dec. 18, 2017, the entire content of which is incorporated herein by reference.

### TECHNICAL FIELD

The present disclosure relates to the field of agricultural unmanned aerial vehicle (UAV) and, more particularly, to a flow control method, apparatus, and system for a liquid extraction apparatus of a plant protection machine.

### BACKGROUND

In order to achieve precise spraying in the field of agricultural spraying, a spraying flow rate of pesticides needs to be accurately controlled during a spraying operation. In addition, when the pesticides in a water pump are used up and need to be fed, in order to achieve an accurate feeding and avoid the water pump being fed too full or too little, generally a feeding flow rate also needs to be accurately controlled during a feeding process. In conventional control methods, the water pump is used in conjunction with a flow meter, and a closed-loop control of a pump throttle is performed using the flow meter. However, because the flow meter is a fragile device, if the flow meter is damaged, the accurate spraying or accurate feeding cannot be achieved.

### SUMMARY

In accordance with the disclosure, there is provided a flow control method including obtaining a target flow rate for extracting liquid, determining a target rotation speed of a liquid extraction apparatus corresponding to the target flow rate based on a preset association relationship between a flow rate and a rotation speed of the liquid extraction apparatus, and controlling the liquid extraction apparatus to rotate at the target rotation speed to extract liquid.

Also in accordance with the disclosure, there is provided a liquid extraction apparatus including a receiving body including a liquid inlet and a liquid outlet, a driving assembly connected to the receiving body and configured to drive liquid to flow into the receiving body through the liquid inlet and flow out of the receiving body through the liquid outlet, and one or more processors individually or cooperatively configured to obtain a target flow rate for extracting liquid, determine a target rotation speed of a liquid extraction apparatus corresponding to the target flow rate based on a preset association relationship between a flow rate and a rotation speed of the liquid extraction apparatus, and control the liquid extraction apparatus to rotate at the target rotation speed to extract liquid.

Also in accordance with the disclosure, there is provided a flow control system including a plant protection machine including a tank and a sprayer, and a liquid extraction apparatus mounted at the plant protection machine and configured to extract liquid in the tank into the spraying device for spraying. The liquid extraction apparatus includes a receiving body including a liquid inlet and a liquid outlet, a driving assembly connected to the receiving body and configured to drive liquid to flow into the receiving body through the liquid inlet and flow out of the receiving body through the liquid outlet, and one or more processors individually or cooperatively configured to obtain a target flow rate for extracting liquid, determine a target rotation speed of a liquid extraction apparatus corresponding to the target flow rate based on a preset association relationship between a flow rate and a rotation speed of the liquid extraction apparatus, and control the liquid extraction apparatus to rotate at the target rotation speed to extract liquid.

### BRIEF DESCRIPTION OF THE DRAWINGS

FIG. 1 is a schematic flow chart of a flow control method for a liquid extraction apparatus of a plant protection machine consistent with embodiments of the disclosure.

FIG. 2 is a schematic flow chart of a calibration method for a liquid extraction apparatus consistent with embodiments of the disclosure.

FIG. 3 is a schematic flow chart of another calibration method for a liquid extraction apparatus consistent with embodiments of the disclosure.

FIG. 4 is a schematic structural diagram of a liquid extraction apparatus of a plant protection machine consistent with embodiments of the disclosure.

FIG. 5 is a schematic structural diagram of a flow control system for a liquid extraction apparatus of a plant protection machine consistent with embodiments of the disclosure.

FIG. 6 is a schematic structural diagram of another flow control system for a liquid extraction apparatus of a plant protection machine consistent with embodiments of the disclosure.

### DETAILED DESCRIPTION OF THE EMBODIMENTS

In order to provide a clearer illustration of technical solutions of disclosed embodiments, example embodiments will be described with reference to the accompanying drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

Exemplary embodiments will be described with reference to the accompanying drawings. Unless conflicted, the exemplary embodiments and features in the exemplary embodiments can be combined with each other.

During a spraying process of a plant protection machine, a flow control is generally implemented using the following two implementations.

In one implementation, a water pump, (e.g., a centrifugal pump, a diaphragm pump, or the like) can be used in conjunction with a flow meter. During a spraying process, the flow control can be achieved through a closed-loop control of the pump using the flow meter. The flow meter is an important device for realizing the flow control in this implementation, such that an accuracy of the flow control can be determined by a working state of the flow meter. However, the flow meter is a fragile device and is easily damaged in practical applications. Therefore, it is easy to fail to achieve the accurate flow control due to any damage of the flowmeter in actual scenarios.

In another implementation, a peristaltic pump can be used to achieve the flow control during the spraying process. However, a rubber tube of the peristaltic pump is a fragile component and needs to be replaced regularly. In addition, a spraying effect that the spray control can achieve by using the peristaltic pump alone can be poor. The peristaltic pump needs to cooperate with, for example, a centrifugal pump or another device, to achieve the desired spraying effect, such that the cost can be high.

To solve the technical problems described above, the present disclosure provides a flow control method for a liquid extraction apparatus of a plant protection machine. After a target flow rate of liquid to be extracted is obtained, according to a relationship between a preset flow rate and a rotation speed of the liquid extraction apparatus (including, but not limited to, a diaphragm pump), the rotation speed of the liquid extraction apparatus corresponding to the target flow rate can be determined. As such, the flow rate can be controlled to be the target flow rate by controlling the liquid extraction apparatus to rotate at the corresponding rotation speed.

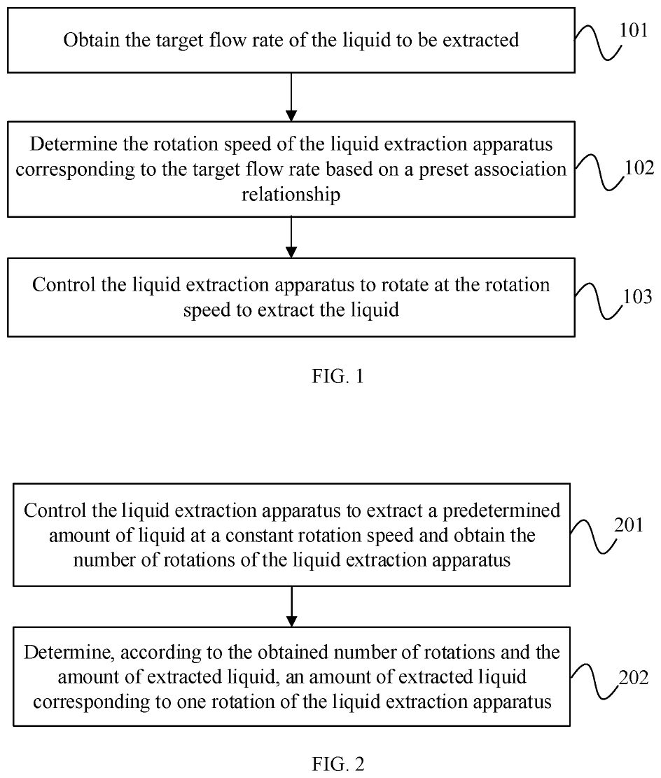

FIG. 1 is a schematic flow chart of an example flow control method for the liquid extraction apparatus of the plant protection machine consistent with the disclosure. The method may be implemented by the liquid extraction apparatus or a flow control system that includes the liquid extraction apparatus.

As shown in FIG. 1, at 101, the target flow rate of the liquid to be extracted is obtained. The target flow rate refers to a target amount of liquid to be extracted by the liquid extraction apparatus in a unit time. The target flow rate of the plant protection machine can be obtained according to a flight height and flight speed of the plant protection machine.

In some embodiments, the liquid extraction apparatus may have a pump structure. The pump structure can include, but is not limited to, a centrifugal pump and a diaphragm pump. Different rotation speeds of the liquid extraction apparatus can correspond to different flow rates.

At 102, the rotation speed of the liquid extraction apparatus corresponding to the target flow rate is determined based on a preset association relationship. The rotation speed corresponding to the target flow rate is also referred to as a “target rotation speed.” The preset association relationship refers to a relationship between the flow rate and the rotation speed of the liquid extraction apparatus. In some embodiments, the preset association relationship can include that the flow rate is directly proportional to the rotation speed of the liquid extraction apparatus. For example, the proportional relationship between the flow rate and the rotation speed of the liquid extraction apparatus can be expressed as:

V=S×K

where the parameter V represents the flow rate, S represents the rotation speed of the liquid extraction apparatus, and K represents the amount of liquid that the liquid extraction apparatus can extract in one rotation.

The parameter K is a constant and can be obtained when the liquid extraction apparatus is calibrated. For example, during a calibration process, according to the number of rotations when the liquid extraction apparatus extracts a predetermined amount of liquid, an average amount of liquid that the liquid extraction apparatus extracts in one rotation (i.e., parameter K) can be calculated. It can be appreciated that the proportional relationship described above is only exemplary and not intended to limit the disclosure. As another example, when the liquid extraction apparatus is being calibrated, a pressure gauge can be used to measure a pressure value of the liquid (a value of a liquid pressure), and the corresponding flow rate value can be obtained according to a relationship between the pressure value and the rotation speed value. As such, a secondary calibration of the liquid extraction apparatus can be performed, and a more accurate parameter K can be obtained. The proportional relationship provided here is only exemplary, and not intended to limit the present disclosure.

In some embodiments, the preset association relationship can include that the flow rate has a linear relationship with the rotation speed of the liquid extraction apparatus. For example, the linear relationship between the flow rate and the rotation speed of the liquid extraction apparatus can be expressed as:

V=S×K+b

where the parameter V represents the flow rate, S represents the rotation speed of the liquid extraction apparatus, K represents the amount of liquid that the liquid extraction apparatus can extract in one rotation, and b represents a constant.

During the calibration process, the parameters K and b can be calculated by causing the liquid extraction apparatus to extract the predetermined amount of liquid at different rotation speeds. The linear relationship provided here is only exemplary, and not intended to limit the present disclosure.

At 103, the liquid extraction apparatus is controlled to rotate at the rotation speed to extract the liquid. Different rotation speeds of the liquid extraction apparatus correspond to different flow rates. When the rotation speed of the liquid extraction apparatus corresponding to the target flow rate is determined, the target flow rate can be obtained by controlling the liquid extraction apparatus to rotate at the rotation speed corresponding to the target flow rate, and hence, the accurate flow rate control can be achieved.

Consistent with the disclosure, the target flow rate of the liquid to be extracted can be obtained, and the rotation speed of the liquid extraction apparatus corresponding to the target flow rate can be determined according to the preset association relationship between the flow rate and the rotation speed of the liquid extraction apparatus. The liquid extraction apparatus can be controlled to rotate at the corresponding rotation speed to extract the liquid. The rotation speed of the liquid extraction apparatus corresponding to the target flow rate can be directly determined based on the preset association correlation between the preset flow rate and the rotation speed of the liquid extraction apparatus, without using the flow meter or adding other devices. Therefore, the problem of inaccurate flow control caused by any damage to the flow meter or other devices can be avoided, the accuracy of the flow control can be improved, and the cost of the flow control can be reduced, thereby achieving the accurate spraying or the accurate feeding.

FIG. 2 is a schematic flow chart of an example calibration method for the liquid extraction apparatus consistent with the disclosure. As shown in FIG. 2, at 201, the liquid extraction apparatus is controlled to extract a predetermined amount of liquid at a constant rotation speed and a number of rotations of the liquid extraction apparatus is obtained.

At 202, according to the obtained number of rotations and the amount of extracted liquid, an amount of extracted liquid corresponding to one rotation of the liquid extraction apparatus is determined.

For example, assume that the liquid extraction apparatus extracts a predetermined amount g (the amount can be in volume or mass) of liquid at a constant speed S, and the number of rotations of the liquid extraction apparatus, i.e., the number of rotations completed by the liquid extraction apparatus, for extracting the predetermined amount g of liquid is n. An average amount of liquid exacted by the liquid extraction apparatus in one rotation can be g divided by n. That is, based on the number of rotations for the liquid extraction apparatus to extract the predetermined amount of liquid, the amount of extracted liquid corresponding to one rotation of the liquid extraction apparatus can be determined. The example described above is merely for illustration, and not intended to limit the present disclosure.

Consistent with the disclosure, the liquid extraction apparatus is controlled to extract the predetermined amount of liquid at the constant speed, and the number of rotations of the liquid extraction apparatus is obtained. According to the obtained number of rotations and the amount of extracted liquid, the amount of extracted liquid corresponding to one rotation of the liquid extraction apparatus can be calculated. Based on a preset representation form of the relationship between the flow rate and the rotation speed of the liquid extraction apparatus, the association correlation between the flow rate and the rotation speed of the liquid extraction apparatus can be obtained. Based on this relationship, the flow can be controlled directly by controlling the rotation speed of the liquid extraction apparatus, without the need for the flow meter or to add other devices, which can avoid the problem of inaccurate flow control caused by any damage to the flow meter or other devices. As such, the accuracy of the flow control can be improved and the cost of flow control can be reduced. In addition, the calibration method of the liquid extraction device is simple and easy to perform, the calculation amount is low, and the calibration efficiency is high.

FIG. 3 is a schematic flow chart of another calibration method for the liquid extraction apparatus consistent with the disclosure. As shown in FIG. 3, at 301, the liquid extraction apparatus is controlled to extract the liquid at a plurality of preset rotation speeds until a predetermined amount of liquid is extracted, and a total number of rotations of the liquid extraction apparatus is obtained.

At 302, according to the obtained total number of rotations and the total amount of extracted liquid, the amount of extracted liquid corresponding to one rotation of the liquid extraction apparatus is determined.

For example, assume that the liquid extraction apparatus extracts the liquid at an initial speed S1. After extracting for a period of time at the speed S1, the liquid extraction apparatus continues to extract at a speed S2 until the amount of extracted liquid reaches the predetermined amount g (the amount can be in volume or mass) and stops the extraction. The total number of rotations of the liquid extraction apparatus is obtained as H, and the average amount of liquid exacted by the liquid extraction apparatus in one rotation can be g divided by H. That is, based on the number of rotations corresponding to the liquid extraction apparatus extracting the predetermined amount of liquid, the amount of extracted liquid corresponding to one rotation of the liquid extraction apparatus can be determined. The example described above is merely for illustration, and not intended to limit the present disclosure.

Different from the calibration methods in connection with FIG. 2, the methods in connection with FIG. 3 can obtain the total number of rotations of the liquid extraction apparatus by controlling the liquid extraction apparatus to extract the liquid at the plurality of preset rotation speeds until the predetermined amount of liquid is extracted. Based on the obtained total number of rotations and the total amount of extracted liquid, the amount of extracted liquid corresponding to one rotation of the liquid extraction apparatus can be obtained. As such, an accuracy of the calibration of the liquid extraction apparatus can be improved.

The beneficial effects of the methods in connection with FIGS. 2 and 3 are similar to those of the methods in connection with FIG. 1, and detailed description thereof is omitted herein.

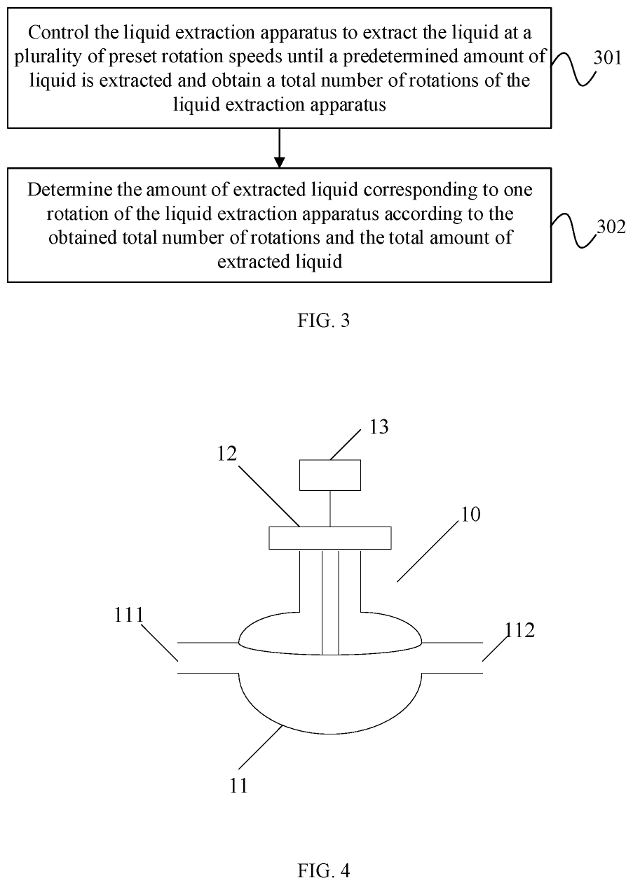

The present disclosure further provides a liquid extraction apparatus for the plant protection machine. FIG. 4 is a schematic structural diagram of an example liquid extraction apparatus 10 consistent with the disclosure. As shown in FIG. 4, the liquid extraction apparatus 10 includes a receiving body 11, a driving assembly 12, and one or more processors 13. The receiving body 11 includes a liquid inlet 111 and a liquid outlet 112. The driving assembly 12 is connected to the receiving body 11 and configured to drive the liquid to flow into the receiving body 11 from the liquid inlet 111 and flow out of the receiving body 11 from the liquid outlet 112. The one or more processors 13 can operate individually or cooperatively, and are configured to obtain the target flow rate of the liquid to be extracted, determine the rotation speed of the liquid extraction apparatus 10 corresponding to the target flow rate based on the preset association relationship, and control the liquid extraction apparatus 10 to rotate at the rotation speed to extract the liquid.

The preset association relationship refers to a relationship between the flow rate and the rotation speed of the liquid extraction apparatus 10. In some embodiments, the preset association relationship can include that the flow rate is proportional to the rotation speed of the liquid extraction apparatus 10. In some embodiments, the preset association relationship can include that the flow rate has the linear relationship with the rotation speed of the liquid extraction apparatus 10.

In some embodiments, the one or more processors 13 can be further configured to calibrate the liquid extraction apparatus 10. In some embodiments, the one or more processors 13 can be further configured to determine, according to the number of rotations when the liquid extraction apparatus 10 extracts the predetermined amount of liquid, the amount of liquid that the liquid extraction apparatus 10 extracts in one rotation. In some embodiments, the one or more processors 13 can be further configured to perform the secondary calibration by using the pressure gauge to measure the pressure value of the liquid and obtaining the corresponding flow rate value according to the relationship between the pressure value and the rotation speed value.

In some embodiments, the liquid extraction apparatus 10 can have a pump structure. In some embodiments, the liquid extraction apparatus 10 can include a diaphragm pump. The beneficial effects of the apparatuses in connection with FIG. 4 are similar to those of the methods in connection with FIG. 1, and detailed description thereof is omitted herein.

The present disclosure further provides another liquid extraction apparatus. On the basis of the liquid extraction apparatus 10 shown in FIG. 4, the one or more processors 10 can be further configured to control the liquid extraction apparatus 10 to extract the predetermined amount of liquid at the constant rotation speed and to obtain the number of rotations of the liquid extraction apparatus 10, and according to the obtained number of rotations and the amount of extracted liquid, determine the amount of extracted liquid corresponding to one rotation of the liquid extraction apparatus 10.

The beneficial effects of the apparatuses in connection with FIG. 4 are similar to those of the methods in connection with FIG. 2, and detailed description thereof is omitted herein.

The present disclosure further provides another liquid extraction apparatus. On the basis of the liquid extraction apparatus 10 shown in FIG. 4, the one or more processors 10 can be further configured to control the liquid extraction apparatus 10 to extract the liquid at the plurality of preset rotation speeds until the predetermined amount of liquid is extracted and to obtain the total number of rotations of the liquid extraction apparatus 10, and according to the obtained total number of rotations and the total amount of extracted liquid, determine the amount of extracted liquid corresponding to one rotation of the liquid extraction apparatus 10.

The beneficial effects of the apparatuses in connection with FIG. 4 are similar to those of the methods in connection with FIG. 3, and detailed description thereof is omitted herein.

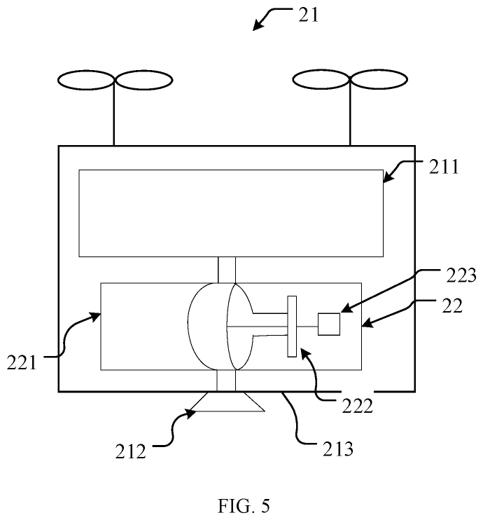

The present disclosure further provides a flow control system for the liquid extraction apparatus of the plant protection machine. FIG. 5 is a schematic structural diagram of an example flow control system for the liquid extraction apparatus of the plant protection machine consistent with the disclosure. As shown in FIG. 5, the flow control system includes a plant protection machine 21 and a liquid extraction apparatus 22. The plant protection machine 21 includes a tank 211 and a spraying device 212 (sprayer). The liquid extraction apparatus 22 can be mounted at the plant protection machine 21 and configured to extract the liquid in the tank 211 into the spraying device 212 for spraying. The liquid extraction apparatus 22 includes a receiving body 221, a driving assembly 222, and one or more processors 223. The receiving body 221 includes a liquid inlet and a liquid outlet (not shown in FIG. 5). The driving assembly 222 is connected to the receiving body 221 and configured to drive the liquid to flow into the receiving body 221 from the liquid inlet and flow out of the receiving body 221 from the liquid outlet. The one or more processors 223 can operate individually or cooperatively, and be configured to obtain the target flow rate of the liquid to be extracted, determine the rotation speed of the liquid extraction apparatus 22 corresponding to the target flow rate based on the preset association relationship, and control the liquid extraction apparatus 22 to rotate at the rotation speed to extract the liquid.

The preset association relationship refers to a relationship between the flow rate and the rotation speed of the liquid extraction apparatus 22. In some embodiments, the preset association relationship can include that the flow rate is proportional to the rotation speed of the liquid extraction apparatus 22. In some embodiments, the preset association relationship can include that the flow rate has the linear relationship with the rotation speed of the liquid extraction apparatus 22.

In some embodiments, the one or more processors 223 can be further configured to calibrate the liquid extraction apparatus 22. In some embodiments, the one or more processors 223 can be further configured to determine, according to the number of rotations when the liquid extraction apparatus 22 extracts the predetermined amount of liquid, the amount of liquid that the liquid extraction apparatus 22 extracts in one rotation.

In some embodiments, the plant protection machine 21 can further include a pressure gauge (not shown in FIG. 5). The one or more processors 223 of the liquid extraction apparatus 22 can be further configured to use the pressure gauge to measure the pressure value of the liquid and obtain the corresponding flow rate value according to the relationship between the pressure value and the rotation speed value to perform the secondary calibration of the liquid extraction apparatus 22.

In some embodiments, the liquid extraction apparatus 22 can have a pump structure. In some embodiments, the liquid extraction apparatus 22 can include a diaphragm pump.

In some embodiments, the plant protection machine 21 includes a vehicle body 213, a power system (not shown in FIG. 5), and a flight controller (not shown in FIG. 5). The liquid extraction apparatus 22, the tank 211, and the spraying device 212 can be mounted at the vehicle body 213. The power system can be mounted at the vehicle body 213 and configured to provide a flight power. The flight controller can be connected to the power system and configured to control the plant protection machine 21 to fly.

The beneficial effects of the flow control systems in connection with FIG. 5 are similar to those of the methods in connection with FIG. 1, and detailed description thereof is omitted herein.

The present disclosure further provides another flow control system. On the basis of the flow control system shown in FIG. 5, the one or more processors 223 can be further configured to control the liquid extraction apparatus 22 to extract the predetermined amount of liquid at the constant rotation speed and to obtain the number of rotations of the liquid extraction apparatus 22, and according to the obtained number of rotations and the amount of extracted liquid, determine the amount of extracted liquid corresponding to one rotation of the liquid extraction apparatus 22.

The beneficial effects of the flow control systems in connection with FIG. 5 are similar to those of the methods in connection with FIG. 2, and detailed description thereof is omitted herein.

The present disclosure further provides another flow control system. On the basis of the flow control system shown in FIG. 5, the one or more processors 223 can be further configured to control the liquid extraction apparatus 22 to extract the liquid at the plurality of preset rotation speeds until the predetermined amount of liquid is extracted and to obtain the total number of rotations of the liquid extraction apparatus 22, and according to the obtained total number of rotations and the total amount of extracted liquid, determine the amount of extracted liquid corresponding to one rotation of the liquid extraction apparatus 22.

The beneficial effects of the flow control systems in connection with FIG. 5 are similar to those of the methods in connection with FIG. 3, and detailed description thereof is omitted herein.

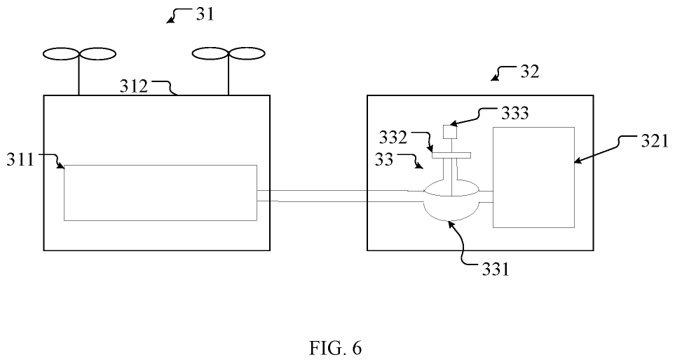

FIG. 6 is a schematic structural diagram of another example flow control system for the liquid extraction apparatus of the plant protection machine consistent with embodiments of the disclosure. As shown in FIG. 6, the flow control system includes a plant protection machine 31, a ground station 32, and a liquid extraction apparatus 33. The plant protection machine 31 includes a tank 311, and the ground station 32 includes a feeding tank 321. The liquid extraction apparatus 33 can be mounted at the ground station 32 and configured to extract the liquid in the feeding tank 321 into the tank 311 to feed the plant protection machine 31.

The liquid extraction apparatus 33 includes a receiving body 331, a driving assembly 332, and one or more processors 333. The receiving body 331 includes a liquid inlet and a liquid outlet (not shown in FIG. 6). The driving assembly 332 is connected to the receiving body 331 and configured to drive the liquid to flow into the receiving body 331 from the liquid inlet and flow out of the receiving body 331 from the liquid outlet. The one or more processors 333 can operate individually or cooperatively, and configured to obtain the target flow rate of the liquid to be extracted, determine the rotation speed of the liquid extraction apparatus 33 corresponding to the target flow rate based on the preset association relationship, and control the liquid extraction apparatus 33 to rotate at the rotation speed to extract the liquid.

The preset association relationship refers to a relationship between the flow rate and the rotation speed of the liquid extraction apparatus 33. In some embodiments, the preset association relationship can include that the flow rate is proportional to the rotation speed of the liquid extraction apparatus 33. In some embodiments, the preset association relationship can include that the flow rate has the linear relationship with the rotation speed of the liquid extraction apparatus 33.

In some embodiments, the one or more processors 333 can be further configured to calibrate the liquid extraction apparatus 33. In some embodiments, the one or more processors 333 can be further configured to determine, according to the number of rotations when the liquid extraction apparatus 33 extracts the predetermined amount of liquid, the amount of liquid that the liquid extraction apparatus 33 extracts in one rotation.

In some embodiments, the ground station 32 can further include a pressure gauge (not shown in FIG. 6). The one or more processors 333 of the liquid extraction apparatus 33 can be further configured to use the pressure gauge to measure the pressure value of the liquid in the feeding tank 321 and obtain the corresponding flow rate value according to the relationship between the pressure value and the rotation speed value of the liquid extraction apparatus 33, such that the secondary calibration of the liquid extraction apparatus 33 can be performed.

In some embodiments, the liquid extraction apparatus 33 can have a pump structure. In some embodiments, the liquid extraction apparatus 33 can include a diaphragm pump.

In some embodiments, the plant protection machine 31 can include a vehicle body 312, a power system, and a spraying device (not shown in FIG. 6). The power system can be mounted at the vehicle body 312 and configured to provide a flight power. The spraying device can be mounted at the vehicle body 312 and configured to spray the liquid in the tank 311.

In some embodiments, the ground station 32 can include a control device (not shown in FIG. 6). The control device can communicatively connected to the plant protection machine 31 and configured to control the plant protection machine 31 to fly and/or spray the liquid. The beneficial effects of the flow control systems in connection with FIG. 6 are similar to those of the methods in connection with FIG. 1, and detailed description thereof is omitted herein.

The present disclosure further provides another flow control system. On the basis of the flow control system shown in FIG. 6, the one or more processors 333 can be further configured to control the liquid extraction apparatus 33 to extract the predetermined amount of liquid at the constant rotation speed and to obtain the number of rotations of the liquid extraction apparatus 33, and according to the obtained number of rotations and the amount of extracted liquid, determine the amount of extracted liquid corresponding to one rotation of the liquid extraction apparatus 33.

The beneficial effects of the flow control systems in connection with FIG. 6 are similar to those of the methods in connection with FIG. 2, and detailed description thereof is omitted herein.

The present disclosure further provides another flow control system. On the basis of the flow control system shown in FIG. 6, the one or more processors 333 can be further configured to control the liquid extraction apparatus 33 to extract the liquid at the plurality of preset rotation speeds until the predetermined amount of liquid is extracted and to obtain the total number of rotations of the liquid extraction apparatus 33, and according to the obtained total number of rotations and the total amount of extracted liquid, determine the amount of extracted liquid corresponding to one rotation of the liquid extraction apparatus 33.

The beneficial effects of the flow control systems in connection with FIG. 6 are similar to those of the methods in connection with FIG. 3, and detailed description thereof is omitted herein.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the exemplary methods described above. The storage medium can be any medium that can store program codes, for example, a USB disk, a mobile hard disk, a read-only memory (ROM), a random access memory (RAM), a magnetic disk, or an optical disk.

For simplification purposes, the division of the functional modules described above is merely exemplary. In practical applications, the functions described above may be implemented by different functional modules. That is, an internal structure of the apparatus can be divided into different functional modules to complete some or all of the functions described above. Detailed descriptions of the operations of exemplary apparatus may be omitted and references can be made to the descriptions of the exemplary methods.

It is intended that the embodiments disclosed herein are merely for illustrating and not to limit the scope of the disclosure. Changes, modifications, alterations, and variations of the above-described embodiments may be made by those skilled in the art without departing from the scope of the disclosure. The scope of the invention can be defined by the following claims or equivalent thereof.

What is claimed is:

1. A flow control method for a plant protection machine comprising:
obtaining a target flow rate for extracting liquid;
determining a target rotation speed of a liquid extraction apparatus corresponding to the target flow rate based on a preset association relationship, the preset association relationship including a relationship between a flow rate and a rotation speed of the liquid extraction apparatus; and
controlling the liquid extraction apparatus to rotate at the target rotation speed to extract liquid.

2. The method of claim 1, wherein the preset association relationship includes that the flow rate is proportional to the rotation speed of the liquid extraction apparatus.

3. The method of claim 1, wherein the preset association relationship includes that the flow rate has a linear relationship with the rotation speed of the liquid extraction apparatus.

4. The method of claim 1, further comprising:
calibrating the liquid extraction apparatus.

5. The method of claim 4, wherein calibrating the liquid extraction apparatus includes determining, according to a number of rotations for the liquid extraction apparatus to extract a predetermined amount of liquid, an amount of liquid that the liquid extraction apparatus extracts in one rotation.

6. The method of claim 5, wherein determining the amount of liquid that the liquid extraction apparatus extracts in one rotation includes:
extracting the predetermined amount of liquid at a constant rotation speed and obtaining the number of rotations of the liquid extraction apparatus; and
determining, according to the number of rotations and the predetermined amount of liquid, the amount of liquid that the liquid extraction apparatus extracts in one rotation.

7. The method of claim 5, wherein determining the amount of liquid that the liquid extraction apparatus extracts in one rotation includes:
controlling the liquid extraction apparatus to extract liquid at a plurality of preset rotation speeds until the predetermined amount of liquid is extracted and obtaining the number of rotations of the liquid extraction apparatus; and
determining, according to the number of rotations and the predetermined amount of liquid, the amount of liquid that the liquid extraction apparatus extracts in one rotation.

8. The method of claim 4, further comprising:
measuring a pressure value of liquid using a pressure gauge; and
obtaining a corresponding flow rate according to a relationship between the pressure value and the rotation speed to perform a secondary calibration for the liquid extraction apparatus.

9. The method of claim 1, wherein the liquid extraction apparatus has a pump structure.

10. A liquid extraction apparatus comprising:
a receiving body including:
a liquid inlet; and
a liquid outlet;
a driving assembly connected to the receiving body and configured to drive liquid to flow into the receiving body through the liquid inlet and flow out of the receiving body through the liquid outlet; and
one or more processors individually or cooperatively configured to:
obtain a target flow rate for extracting liquid;
determine a target rotation speed of a liquid extraction apparatus corresponding to the target flow rate based on a preset association relationship, the preset association relationship including a relationship between a flow rate and a rotation speed of the liquid extraction apparatus; and
control the liquid extraction apparatus to rotate at the target rotation speed to extract liquid.

11. The apparatus of claim 10, wherein the preset association relationship includes that the flow rate has a linear relationship with the rotation speed of the liquid extraction apparatus.

12. The apparatus of claim 11, wherein the one or more processors are further configured to calibrate the liquid extraction apparatus.

13. The apparatus of claim 12, wherein the one or more processors are further configured to determine, according to a number of rotations for the liquid extraction apparatus to extract a predetermined amount of liquid, an amount of liquid that the liquid extraction apparatus extracts in one rotation.

14. The apparatus of claim 13, wherein the one or more processors are further configured to:
extract the predetermined amount of liquid at a constant rotation speed and obtain the number of rotations of the liquid extraction apparatus; and
determine, according to the number of rotations and the predetermined amount of liquid, the amount of liquid that the liquid extraction apparatus extracts in one rotation.

15. The apparatus of claim 13, wherein the one or more processors are further configured to:
control the liquid extraction apparatus to extract liquid at a plurality of preset rotation speeds until the predetermined amount of liquid is extracted and obtain the number of rotations of the liquid extraction apparatus; and
determine, according to the number of rotations and the predetermined amount of liquid, the amount of liquid that the liquid extraction apparatus extracts in one rotation.

16. A flow control system comprising:
a plant protection machine including:
a tank; and
a sprayer; and
a liquid extraction apparatus mounted at the plant protection machine and configured to extract liquid in the tank into the spraying device for spraying, the liquid extraction apparatus including:
a receiving body including:
a liquid inlet; and
a liquid outlet;
a driving assembly connected to the receiving body and configured to drive the liquid to flow into the receiving body through the liquid inlet and flow out of the receiving body through the liquid outlet; and
one or more processors individually or cooperatively configured to:
obtain a target flow rate for extracting liquid;
determine a target rotation speed of a liquid extraction apparatus corresponding to the target flow rate based on a preset association relationship, the preset association relationship including a relationship between a flow rate and a rotation speed of the liquid extraction apparatus; and
control the liquid extraction apparatus to rotate at the target rotation speed to extract liquid.

17. The system of claim 16, wherein the one or more processors are further configured to calibrate the liquid extraction apparatus.

18. The system of claim 17, wherein the one or more processors are further configured to determine, according to a number of rotations for the liquid extraction apparatus to extract a predetermined amount of liquid, an amount of liquid that the liquid extraction apparatus extracts in one rotation.

19. The system of claim 16, wherein:
the plant protection machine further includes a pressure gauge; and
the one or more processors of the liquid extraction apparatus are further configured to:
measure a pressure value of liquid using the pressure gauge; and
obtain a corresponding flow rate according to a relationship between the pressure value and the rotation speed to perform a secondary calibration for the liquid extraction apparatus.

20. The system of claim 16, wherein:
the plant protection machine includes:
a vehicle body;
a power system mounted at the vehicle body and configured to provide a flight power; and
a flight controller connected to the power system and configured to control the plant protection machine to fly; and
the liquid extraction apparatus, the tank, and the sprayer are mounted at the vehicle body.
